(19) United States
(12) Patent Application Publication
(10) Pub. No.: US 2023/0375023 A1
(43) Pub. Date: Nov. 23, 2023

(54) FURNITURE, CONNECTORS AND JOINTS THEREOF, AND A METHOD FOR ASSEMBLING SUCH FURNITURE

(71) Applicant: IKEA Supply AG, Pratteln (CH)

(72) Inventors: Ola ROBÉRT, Xu Hui District, Shanghai (CN); Victor SPIREA, Warszawa (PL)

(21) Appl. No.: 18/027,325

(22) PCT Filed: Sep. 21, 2021
(86) PCT No.: PCT/SE2021/050911

§ 371 Date: Mar. 20, 2023

(30) Foreign Application Priority Data
Sep. 21, 2020 (WO) PCT/CN2020/116448
Jun. 3, 2021 (SE) 2150711-6

(51) Int. Cl. F16B 12/14; F16B 12/24

(52) U.S. Cl. CPC F16B 12/14; F16B 12/24

(57) ABSTRACT

A furniture connector (30) for establishing attachment between two pre-manufactured furniture parts (20a-b) is provided. The furniture connector (30) comprises a screw (32), and a washer (34) configured to receive the screw (32) and comprising a plate (34a) having a radius (R), and a through hole (34b) arranged in said plate (34a), wherein the periphery of said through hole (34b) extends into a truncated cone (34c) in a direction away from said plate (34a).

### TECHNICAL FIELD

The present invention relates to furniture, and assembly of furniture. More particularly, the present invention is directed towards furniture and connectors and joints thereof for compensating for variations in dimensions of the furniture material.

### BACKGROUND

Furniture is manufactured by a variety of different materials. Wood, being one preferred material, is especially suitable for large scale batch production of furniture due to the possibility to produce the furniture parts with dimensions being within the preset tolerances. However, in some cases it is desired to use natural material which cannot be produced in large quantity with well-defined dimensions. It may for example be desired to produce furniture using natural tree trunks, or forming furniture legs directly from certain tree branches or from saplings. Another natural material for furniture is rattan.

Rattan is already extensively used for manufacturing and forming of various furniture such as chairs, tables, sofas, etc. Rattan is a generic name for a plurality of species of climbing palms, all having a flexible wood-like stem. The characteristics of rattan is therefore more of a liana than traditional, common wood. Two examples of rattan species useful for furniture production include Lambang (Calamus ornatus) and Batang (Calamus zollingeri).

The stem is typically having a diameter of 2-5 cm, being tapered along its length due to variations during growth.

A piece of rattan used for furniture has a relatively hard and rigid outer shell, and a solid, although substantially more soft, inner core. Rattan furniture is normally hand-made due to variations of dimensions of the rattan material, which also means that rattan furniture is transported as fully assembled. This is however a major drawback, and especially when compared to the articles offered by the wooden furniture industry, which has been extremely successfully in developing so called “knock-down” furniture. This kind of furniture is ready-to-assemble, i.e. it is sold as a group of separate components with assembly instructions to connect the components. Hence, such furniture can be flat-packed which offers a number of advantages in terms of cost efficiency and transport/storage.

As rattan is normally used in its natural form and dimensions, there is so far no commercially successful technique for industrial large quantity manufacturing of rattan furniture, still maintaining the original and unique appearance of hand-made articles and allowing the rattan furniture to be sold and distributed in a knock-down configuration. Industrial manufacturing will normally require tight tolerances for high throughput and yield, which is incompatible with the intrinsic properties of rattan and other natural plant-based parts, including also other monocots than rattan and also bamboo, where the outer surface of the plant when growing is at least to some extent influencing the outer surface of the final furniture component.

In view of this, new processes and components are desired in order to allow for improved manufacturing techniques for furniture.

### SUMMARY

It is an object of the present invention to wholly or partly overcome the above disadvantages and drawbacks of the prior art. More specifically, it is an object to provide furniture which can be assembled from a knock-down configuration of pre-manufactured furniture parts having certain variations in dimensions, as well as components and methods thereof.

According to a first aspect a furniture connector is provided. The furniture connector is configured to establish attachment between two pre-manufactured furniture parts, and comprises a screw, and a washer. The washer is configured to receive the screw and it comprises a plate having a radius, and a through hole arranged in said plate, wherein the periphery of said through hole extends into a truncated cone in a direction away from said plate. The furniture connector will provide support to the strength of a furniture joint as the head of screw will be prevented to cut into or go into the furniture part, which is particularly advantageous for rattan furniture due to non-controllable variations of rattan density.

The plate of the washer may be circular, square, rectangular, elliptical and have other outer shapes as well. The plate is bent, preferably to a curvature having a radius similar to that of the furniture part to which it is to be mounted, and an even embracing of the associated furniture part along the outer surface, having a rounded shape, is thereby accomplished.

The outer dimension of the plate, such as the diameter in case of a circular plate or the side in case of a triangular, square or rectangular plate, may be between 1.5 and 4 cm, preferably between 2 and 3 cm and, more preferably between 2.4 and 2.6 cm. This has proven to be particularly advantageous for pole-shaped rattan furniture parts.

The apex angle of the truncated cone of the washer may be between 40° and 80°, preferably between 55° and 65°. The screw head will thereby be fully accommodated by the washer.

The length of the truncated cone of the washer may be between 2 and 10 mm, preferably between 4 and 6 mm. The screw head may thereby fit inside the truncated cone, while still allowing different angle of extension of the screw.

The radius of the bending of the plate may be between 5 and 35 mm, preferably between 8 and 32 mm, more preferably between 10 and 25 mm, even more preferably between 15 and 20 mm. This has proven to fit well with pole-shaped furniture parts, in particular when used for rattan furniture.

The screw may comprise a screw head, a threaded portion, and a non-threaded portion arranged between the screw head and the threaded portion.

The screw head may be tapered. This configuration will provide improved engagement with the washer, especially allowing for different angles of the screw relative the orientation of the washer.

The length of the optional non-threaded portion of the screw may be between 5 and 30 mm, preferably between 10 and 25 mm, such as 20 mm. An improved engagement of the screw with the two furniture parts is thereby accomplished, and reduced complexity of manufacturing is accomplished as the threads does not extends along the full length of the screw. Another advantage is that the non-threaded portion, due to its smaller diameter compared to the threaded portion, will allow for deviations of the angle of the screw relative the washer.

The thread pitch of the threaded portion of the screw may be between 2 and 4 mm, preferably between 2 and 3 mm. The major diameter of the threads of the screw may be between 4 and 8 mm, preferably between 5 and 7.5 mm, and even more preferably between 5.5 and 7 mm. The minor diameter of the threads of the screw may be between 3 and 6 mm, preferably between 3.5 and 5.5 mm, and even more preferably between 4.0 and 4.5 mm. These dimensions, alone or in combination, have proven to provide excellent engagement with the material of the furniture parts, especially if at least one of the first and second furniture parts is made of rattan.

According to a second aspect, a kit for forming a furniture joint is provided. The kit comprises a furniture connector according to the first aspect, a first furniture part and a second furniture part. The screw of the furniture connector is arranged to be inserted in a pre-drilled hole of the first furniture part and to be screwed into a pre-drilled hole of the second furniture part, thereby attaching the first furniture part to the second furniture part.

The pre-drilled hole of the first furniture part has an exterior end arranged to be opposite to the second furniture part and which may have a conical shape, and the cone of the washer may be configured to be received by the exterior end of the pre-drilled hole of the first furniture part. Hence, the washer will fit within the pre-drilled hole, thereby providing a robust accommodation of the force of the screw.

The pre-drilled hole of the first furniture part may extend in a radial direction of a rounded portion of the first furniture part. This allows the furniture parts to be connected to each other at a right angle.

The screw may extend in the radial direction of a rounded portion of the first furniture part, the rounded portion being tilted an angle from being perpendicular to the longitudinal direction of the screw, preferably the angle β being within, ±15°. Hence, the furniture parts may be connected at different angles while still allowing the washer to be flush with the first furniture part.

Instead of extending in the radial direction, the screw may extend in a tangential direction of a rounded portion of the first furniture part. By tangential is means possibly out of centre, but still perpendicular to the fibre direction of the rounded portion of the first furniture part.

The pre-drilled hole of the second furniture part may extend in a radial direction of the second furniture part, or the pre-drilled hole of the second furniture part may extend in an axial direction of the second furniture part. Different joints are thereby allowed, using the same furniture connector.

The pre-drilled hole of the second furniture part may extend from an axial end of the second furniture part, wherein said axial end may have a conical shape. Having a tapered end allows for facilitated alignment of the second furniture part relative the first furniture part.

The pre-drilled hole of the first furniture part may have an interior end arranged adjacent to the second furniture part and having a conical shape, and the axial end of the second furniture part may be arranged to be at least partly received by the interior end of the pre-drilled hole of the first furniture part. This provides for improved connection between the first and second furniture parts. In particular, a conical friction engagement may be provided between the conically shaped axial end of the second furniture part and the conically shaped interior end of the pre-drilled hole of the first furniture part. Preferably the sole point of contact between the axial end of the second furniture part and the interior end of the pre-drilled hole of the first furniture part being the respective conical surfaces. A number of advantages are thereby accomplished. First, assuming a horizontal joint (i.e. the screw is extending horizontally), vertical loads (static and/or dynamic and/or fatigue loads) during use will not act directly on the screw. Instead, the furniture joint will withstand the load. Secondly, the conical joint will always be tight enough in the axial direction when the screw is tightened. Thirdly, the conical joint will also support to stabilize the construction and robustness of the furniture, as the screw will not be allowed to be easily pulled out of the furniture parts.

The conically shaped axial end of the second furniture part and the conically shaped interior end of the pre-drilled hole of the first furniture part may thus be designed such that after mounting, an axial gap is provided between the edge of the axial end and the inner end of the interior end.

The axial length of the axial gap may be in the range of 0.5-4 mm, preferably in the range of 1-2 mm.

At least one of the first furniture part and the second furniture part may be at least partly made of rattan. Furthermore, both the first and the second furniture parts may be made from rattan.

The second furniture part may be provided with a dowel extending across the path of the pre-drilled hole of the second furniture part, preferably the dowel is made from a wooden material, more preferably a wood fiber direction of the dowel extends in a direction being perpendicular to the longitudinal direction of the screw. Hence, the strength of the screw connection is increased.

According to a third aspect, a piece of furniture is provided, comprising at least one kit forming a furniture joint according to the second aspect.

At least one of the first and second furniture parts may be made of rattan, or other plant-based species, such as monocots or bamboo.

The first and/or the second furniture part may form part of pre-manufactured furniture modules, wherein the furniture modules may have a planar shape. Preferably the piece of furniture is entirely made up furniture modules having a planar shape and/or being arranged for being flat-packed. This allows the furniture to be pre-manufactured in modules, and flat-packed to a customer which performs final assembly of the piece of furniture using the furniture connector described earlier.

The piece of furniture may comprise a plurality of pre-manufactured furniture modules forming a seat, a back piece, and two side pieces, respectively, wherein at least one furniture module comprises a first furniture part, and at least one furniture module comprises a second furniture part.

According to a fourth aspect, a method for manufacturing a piece of furniture suitable for being flat-packed is provided. The method comprises i) providing at least two pre-manufactured furniture modules, wherein at least one furniture module comprises a first furniture part, and at least one furniture module comprises a second furniture part, and ii) providing at least one furniture connector according to the first aspect, and/or at least one kit for forming a furniture joint, wherein said first and second furniture parts are configured to be connected by means of said at least one furniture connector and/or by means of said kit.

### BRIEF DESCRIPTION OF THE DRAWINGS

The invention and its many advantages will be described in more detail below with reference to the accompanying schematic drawings, which for the purpose of illustration show some non-limiting embodiments and in which

FIGS. 1a-c are isometric views of furniture according to various embodiments;

FIG. 2a is an isometric view of pre-manufactured rattan furniture modules according to an embodiment, shown in a knock-down configuration,

FIG. 2b is an exploded view of a rattan furniture formed by the pre-manufactured furniture modules shown in FIG. 2a,

FIGS. 3a-c are views of a radial engagement of a furniture connector according to an embodiment;

FIGS. 4a-c are views of another radial engagement of the furniture connector shown in FIGS. 3a-c;

FIG. 5a are various views of a washer forming part of the furniture connector shown in FIGS. 3a-c, and 4a-c;

FIG. 5b is an isometric view of a screw forming part of the furniture connector shown in FIGS. 3a-c, and 4a-c;

FIGS. 6a-c show a radial-radial joint according to an embodiment;

FIGS. 7a-b show a radial-axial joint according to an embodiment;

FIGS. 8a-b show a radial-axial joint according to another embodiment;

FIG. 9a is a cross-sectional view of a radial-axial joint according to an embodiment;

FIG. 9b is a cross-sectional view of a radial-axial joint according to another embodiment; and

FIG. 10 is a schematic view of a method according to an embodiment.

### DETAILED DESCRIPTION

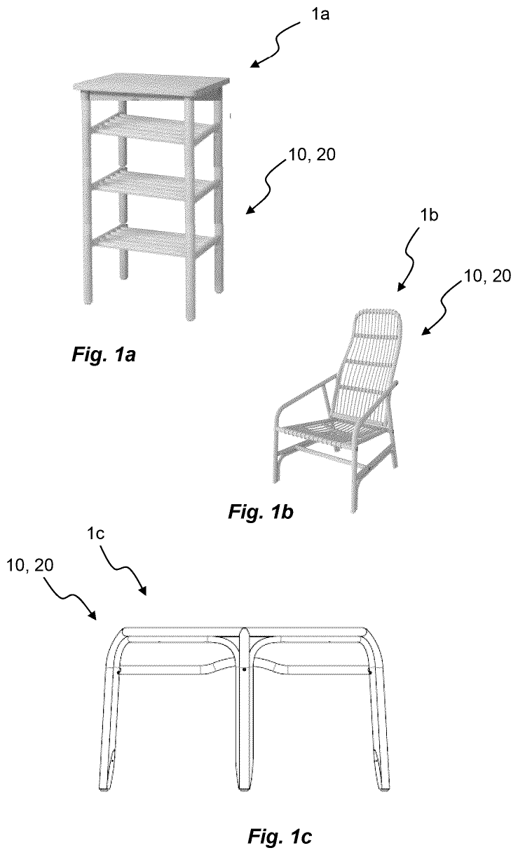

Starting in FIGS. 1a-c, different furniture 1a-c are shown. In FIG. 1a a shelf 1a is shown; in FIG. 1b a chair 1b is shown; and in FIG. 1c a sofa table 1c is shown. Although these furniture 1a-c are very different from each other in terms of use and construction, they could all be manufactured so that they share the common feature of having one or more furniture modules 10 comprising at least one furniture part 20 being made of a natural material, such as rattan, round wood, etc., which makes it impossible to control its dimensions for normal industrial furniture manufacturing processes.

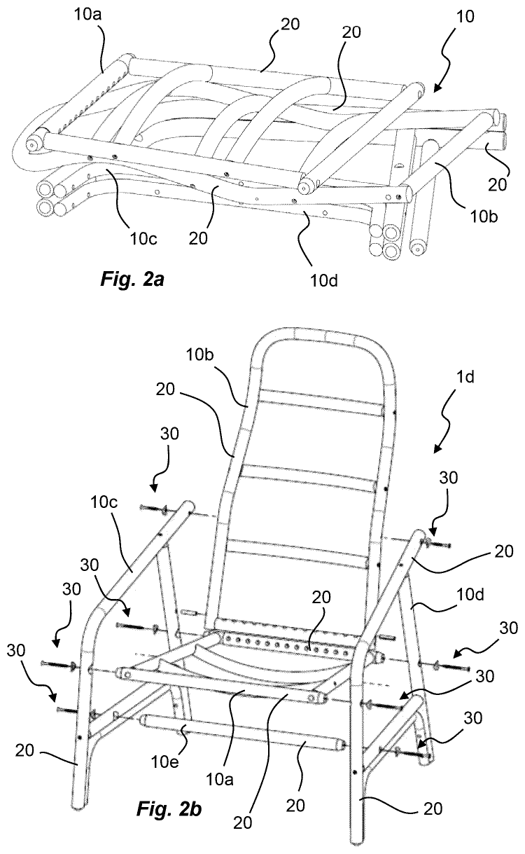

In FIGS. 2a-b, a more detailed example of a furniture 1d according to an embodiment is shown. The furniture 1d is a chair made of a plurality of pre-manufactured furniture modules 10, which are assembled to the final chair 1d by using a plurality of furniture connectors 30, as will be described further on.

In FIG. 2a the furniture modules 10 are shown in a flat, or knocked-down configuration. The furniture modules 10 comprise a seat 10a, a back rest 10b, and two side pieces 10c-d. Importantly, in order to benefit from the advantages associated with know-down packaging and transport, each one of the pre-manufactured furniture modules 10 has a substantially planar shape. The term “planar” is not to be interpreted in a strict sense; a relative meaning should be applied. Hence, as an example the seat 10a and the back rest 10b are each much more planar than if they were to be connected to form an L-shape.

In the shown example, each pre-manufactured furniture module 10 has a rattan frame, forming the outer boundaries of the pre-manufactured furniture module 10. The seat 10a and the back rest 10b, and optionally also the side pieces 10c-d, may however be provided with some kind of surface cover, e.g. rattan wicker or similar.

The side pieces 10c-d do not only form armrests, but also the legs of the chair 1d. In the erected state, as indicated in FIG. 2b, the rattan chair 1d is a rigid furniture providing solid support for a person using the chair 1d.

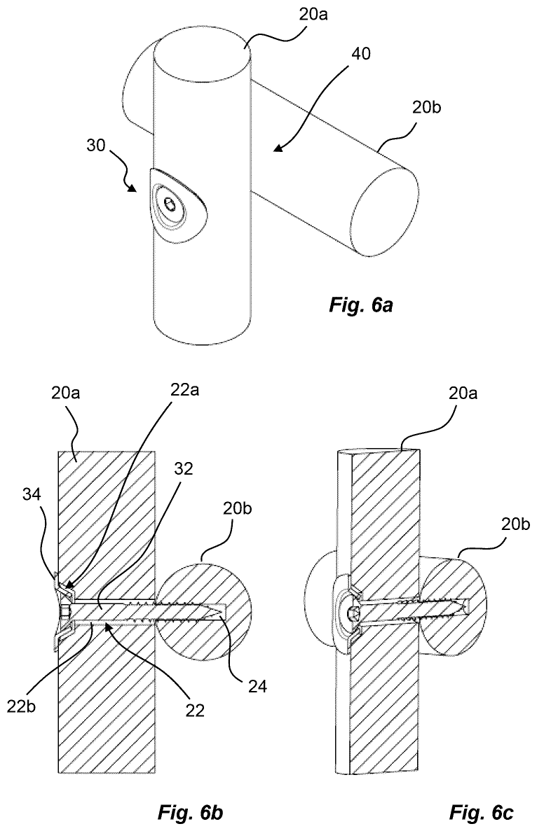

The rattan frame of each furniture module 10a-d, or at least parts thereof, represents a furniture part 20 forming part of one or more furniture joints (see FIGS. 6-9) together with the furniture connectors 30.

In order to allow the end user to assemble the pre-manufactured furniture modules 10 into the final chair 1d as indicated in FIG. 2b, it is necessary to provide the furniture connectors 30 being adapted and optimized for connecting furniture parts 20.

Instead of a fully hand-made rattan furniture, it has been realized that while each furniture module 10 may be produced in a factory, the dimensions will not be identical due to the intrinsic properties of the material. Hence, prior art connectors cannot be used to assemble the furniture modules 10, as these connectors require tight tolerances. Instead, as can be seen in FIG. 2b, the furniture 1d is assembled from a knocked-down configuration, as shown in FIG. 2a, by an end consumer.

For this, a plurality of furniture connectors 30 are provided. As can be seen in FIG. 2b two furniture connectors 30 are used to connect a side piece 10c-d to the seat 10a, and one connector 30 is used to connect each side piece 10c-d to the back rest. As is further shown, a cross beam 10e is connected to each side piece 10c-d by means of two furniture connectors 30. As is evident from FIG. 2b, a complex furniture 1d can be assembled using similar, however not necessarily identical, connectors 30.

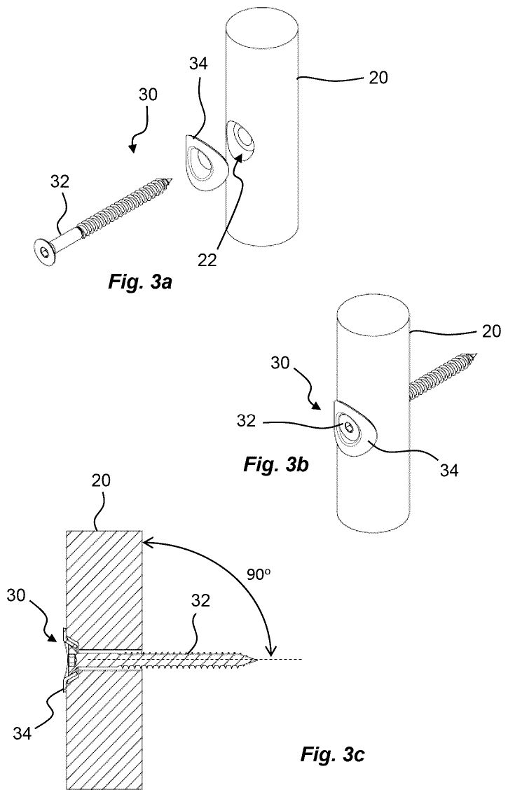

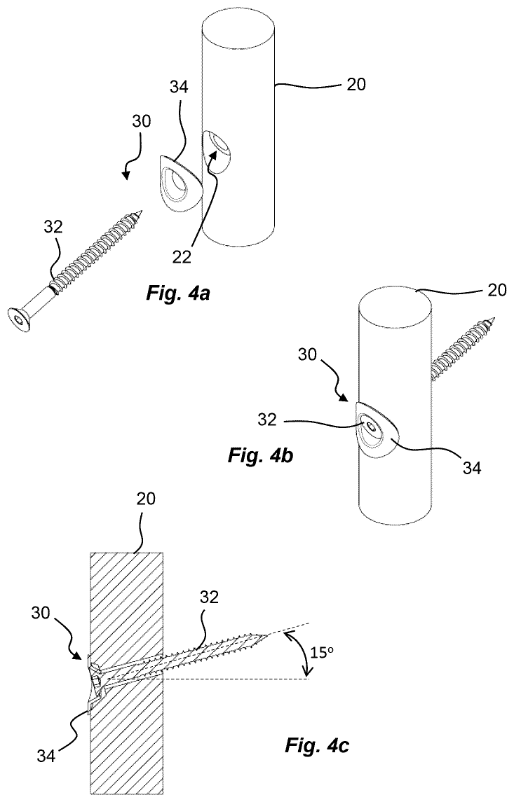

In FIGS. 3-4, the furniture connector 30 is shown in further details, together with a furniture part 20 for facilitating the understanding of the furniture connector 30 operates. Starting in FIGS. 3a-b, each furniture connector 30 comprises a screw 32 and a washer 34.

The washer 34 is inserted into a pre-drilled hole 22 of the furniture part 20, which extends in the radial direction of the furniture part 20. Although the shown furniture part 20 has a cylindrical shape, it should be mentioned that the term “radial direction” would indicate the same, cross-longitudinal direction even if the furniture part 20 would have a non-circular cross-section. Once the washer 34 is positioned correctly relative to the furniture part 20, the screw 32 is inserted through the washer 34 as shown in FIG. 3b. As shown in FIG. 3c, due to the direction of the pre-drilled hole 22, the screw 32 will protrude out from the furniture part 20 at 90° relative the longitudinal, axial direction.

The same screw 32 and washer 34 are shown in FIGS. 4a-c. However, in this embodiment the pre-drilled hole 22 of the furniture part 20 is tilted by 15°, thereby causing a corresponding direction of the screw 32 once inserted into the pre-drilled hole 22. Importantly, this tilted configuration does not require any modification of the washer 34, or how it is inserted into the pre-drilled hole 22. Instead, the washer 34 is dimensioned to accommodate this tilting so that it will appear identical to a completely radial direction of the pre-drilled hole 22, as shown in FIGS. 3a-c. When viewing the screw 32 from the washer 34 side, its head will appear as fully accommodated within the washer 34.

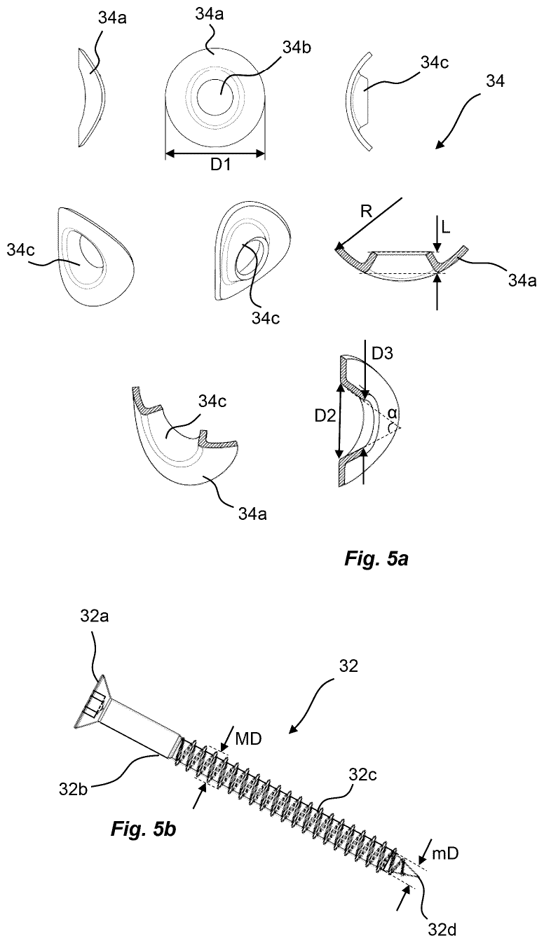

The washer 34 is further shown in FIG. 5a. The washer 34 has a plate 34a, being bent to exhibit a radius R. In the shown example, the plate 34a is bent to form a semi-cylindrical body (e.g. by bending the plate around a cylindrical body). The plate 34a is circular, however other shapes are also possible such as rectangular, square, elliptical, triangular or any other suitable shape.

A through hole 34b is provided, preferably at the center of the plate 34a, and a circular tapered sidewall 34c extends from the periphery of the through hole 34b, in the same direction as the curvature of the plate 34a. Hence, the periphery of the through hole 34b extends into a truncated cone 34c in a direction away from the plate 34a.

Examples of suitable dimensions are as follows. The diameter D1 of the plate 34a, when circular, is preferably in the range of 15-40 mm, even more preferably about 25 mm. The curvature of the plate 34a is made with a radius R of approximately 12-20 mm. The diameter D2 of the through hole 34b is approximately 15 mm, and the tapered angle α, i.e. the apex angle, of the truncated cone 34c is about 60° such that the distal diameter D3 of the truncated cone 34c, when the truncate cone 34c has a length L of about 5 mm, is about 9 mm.

An example of a screw 32 forming part of the furniture connector 30 is shown in FIG. 5b. The screw 32 has a countersunk head 32a, whereby the countersunk angle is approximately 45°. The height of the screw head 32a is about 3,5 mm, followed by a non-threaded upper portion 32b. The diameter of the upper portion 32b is approximately 4-6 mm, and the length of the non-threaded portion 32b is about 15 mm. The screw 32 has a threaded section 32c having a length of approximately 35 to 70 mm, depending on the total length of the screw 32. For the above lengths for the threaded section 32c, the total length of the screw 32 (i.e. the total length of the threaded section 32c, the upper portion 32b, and the head 32a) is between 40 and 100 mm.

Preferably, the screw 32 has a sharp apex 32d in order to compensate for deviations in drilling tolerances of the furniture parts 20 and to improve guiding of the screw 32.

The thread pitch of the threaded portion 32c is preferably approximately 2.4 mm; it has been discovered that such thread pitch will cut less fibers if the furniture parts 20 are made of rattan.

Another characteristic of the screw 32 is the significant difference between the major diameter of the threads and the minor diameter of the threads, which provides additional advantages in case the associated furniture part 20 is made of rattan. As rattan is relatively soft, the material can easily be damaged if the grip of the material is not strong enough, leading to overturning of the screw 32. In the shown example, the major diameter MD of the threads is about 6.3 mm, while the minor diameter mD of the threads is about 4.4 mm. The ratio between the major diameter MD of the threads and the minor diameter mD of the threads is thereby in the range of 1.2-2.0, preferably 1.4-1.7, such as around 1.58. The thread angle is approximately 40°.

Now turning to FIGS. 6a-c, operation of the furniture connector 30 is shown according to a first example. Here, the furniture connector 30 forms a furniture joint 40 together with two associated furniture parts 20a-b. As can be seen in FIG. 6a, the furniture connector 30 is used to rigidly connect a first furniture part 20a to a second furniture part 20b in a radial-radial configuration.

Each furniture part 20a-b forms part of a respective furniture module 10, as explained earlier with reference to FIGS. 2a-b.

As is further shown in FIGS. 6b-c, the first furniture part 20a is provided with a pre-drilled hole 22 extending through the first furniture part 20a in a radial direction, i.e. perpendicular to the axial direction of the first furniture part 20a. The pre-drilled hole 22 of the first furniture part 20a is provided with an exterior conical opening section 22a for receiving the truncated cone 34c of the washer 34. From the exterior section 22a, the pre-drilled hole 22 extends substantially cylindrical, i.e. to a section 22b of constant diameter.

The second furniture part 20b is also provided with a pre-drilled hole 24, also extending in the radial direction of the second furniture part 20b. The pre-drilled hole 24 of the second furniture part 20b does not extend entirely through the second furniture part 20b. The diameter of the pre-drilled hole 24 of the second furniture part 20b is less than the diameter of the pre-drilled hole 22 of the first furniture part 20a, in particular less than of the cylindrical section 22b.

The screw 32 is dimensioned such that it will not grip the first furniture part 20a, but it can be inserted freely into the pre-drilled hole 22 of the first furniture part 20a. When the screw 32 reaches the pre-drilled hole 24 of the second furniture part 20b, the threads will grip the material of the second furniture part 20b and the screw 32 can be inserted until the screw head reaches the truncated cone of the washer 34. As the screw 32 is further tightened, the second furniture part 20b will be drawn towards the first furniture part 20a to establish a firm connection between the first and second furniture parts 20a-b.

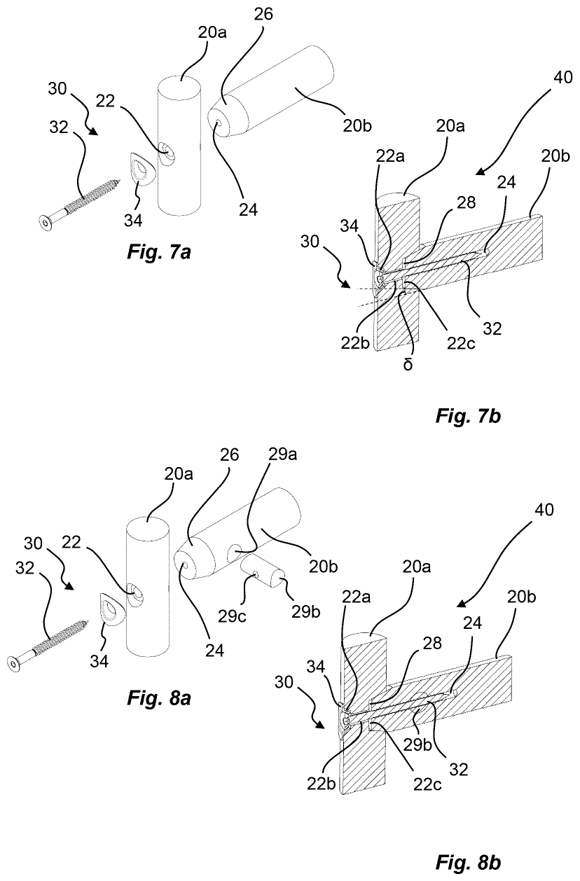

Another example of a furniture joint is shown in FIGS. 7a-b. Here, the first furniture part 20a is almost identical to the first furniture part 20a of FIGS. 6a-c. The connector 30 is also very similar, although the threaded portion of the screw 32 can be made longer than what was shown in FIGS. 6a-c.

Further, the second furniture part 20b is in this embodiment quite different from the second furniture part 22b of FIGS. 6a-c, as the second furniture part 20b is intended to be connected in its axial direction, rather than in a radial direction.

The pre-drilled hole 24 of the second furniture part 20b is extending axially, and preferably centrally, from an axial end 26 of the second furniture part 20b. The axial end 26 is tapered, preferably by an angle δ of approximately 10-20°, such as 15°.

As is clear from FIG. 7b, the pre-drilled hole 22 of the first furniture part 20a is provided with an interior section 22c, forming a cone shaped exit section, such that the cylindrical section 22b of the pre-drilled hole 22 is located between the exterior section 22a and the interior section 22c.

The cone shaped interior section 22c is dimensioned to receive the tapered axial end 26 of the second furniture part 20b. When the joint 40 is formed, as shown in FIG. 7b, the tapered axial end 26 will engage with the cone shaped interior section 22c such that there will be a friction engagement between the first and second furniture parts 20a-b as the screw 32 draws the second furniture part 20b towards the washer 34.

Preferably, the dimensions of the tapered axial end 26 and the cone shaped interior section 22c are designed such that there will be an axial gap 28 between the edge of the axial end 26 and the inner end of the interior section 22c. This axial gap 28 ensures that there will in fact be a friction engagement on the side walls of the end section 26, rather than an axial fixation between the two furniture parts 20a-b. The axial gap 28, preferably being in the range of 0.5-4 mm, such as 1-2 mm in the axial direction, also secures manufacturing tolerance and facilitated customer assembly. However, most important the axial gap 28 ensures that vertical loads during use (either static or fatigue load) will not affect directly on the screw 32, but instead the furniture joint 40 will withstand the load.

The axial gap 28 thus provides for a connection where the sole point of contact between the axial end 26 of the second furniture part 20b and the interior section 22c of the pre-drilled hole 22 of the first furniture part 20a is the respective conical surfaces.

FIGS. 8a-b show another example of a furniture joint 40, using two furniture parts 20a-b and a furniture connector 30. In this example, the first furniture part 20a and the furniture connector 30 are identical to what has been described with reference to FIGS. 7a-b. The second furniture part 20b is provided with a radial hole 29a at a certain axial distance from the axial end 26; the distance is selected such that the screw 32 will be extending through the radial hole 29a when the joint 40 is assembled.

The radial hole 29a is fitted with a dowel 29b. The dowel 29b is preferably provided with a through hole 29c, extending in the axial direction of the second furniture part 20b, but in the radial direction of the dowel 29b. Depending on how critical the furniture joint 40 is, the cross dowel 29b can be added to strengthen the connection of the screw 32 as the screw 32 will in fact grip into the drilled hole 29c of the dowel 29b. Also, in case of rattan material of the second furniture part 20b, the fiber direction of the rattan part 20b will be axial. Thanks to the fiber direction of the dowel 29b, which is in the axial direction of the dowel 29b and hence perpendicular to the fiber direction of the furniture part 20b, the dowel 29b will improve the attachment of the screw 32. The cross dowel 29b may e.g. be made of rattan or solid wood.

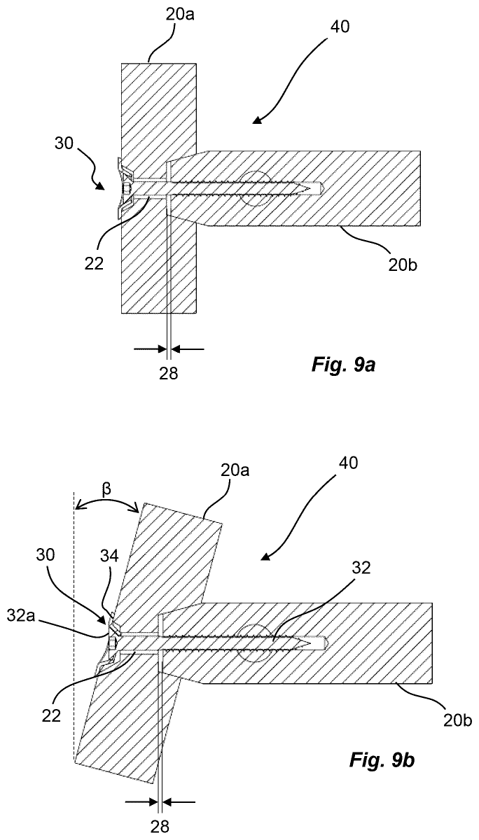

A comparison between two furniture joints 40 is shown in FIGS. 9a-b. The first example, shown in FIG. 9a, is identical to the furniture joint 40 of FIG. 8b. The furniture joint 40 is forming a perpendicular connection between the first furniture part 20a and the second furniture part 20b, as the pre-drilled hole 22 of the first furniture part 20a extends in the radial direction only, i.e. perpendicular to the axial direction of the first furniture part 20a.

In FIG. 9b the pre-drilled hole 22 of the first furniture part 20a is tilted by an angle β of approximately 15° relative the radial direction of FIG. 9a. This means that the first furniture part 20a is tilted by the same angle β relative the vertical direction, assuming that the second furniture part 20b is in a horizontal orientation. The washer 34 will still accommodate the screw head 32a entirely, as clearly shown in FIG. 9b which means that the furniture connector 30, comprising the screw 32 and the washer 34, will work perfectly even if the furniture joint 40 is not perpendicular.

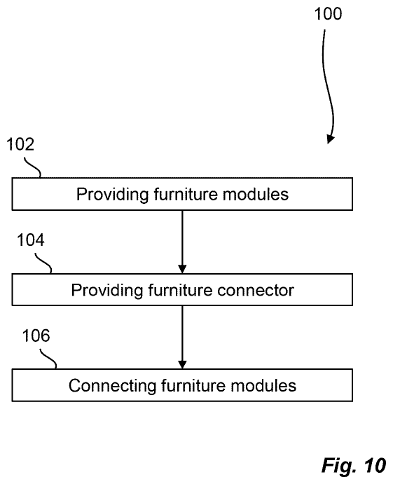

Before turning to FIG. 10, it has been described above that the furniture connector 30 is particularly suitable for use with rattan furniture, and for furniture parts 20a-b being made of rattan.

Rattan is a generally soft material. The density of a rattan piece is not constant in the radial direction, but the outer layer is much harder and stiffer as compared to the core material, which generally has a lower density. The furniture connector 30 described herein has proven to be particularly advantageous not only for rigidly connecting two rattan pieces, i.e. two furniture parts 20a-b being made of rattan, but also to accommodate variations in dimensions of the furniture parts 20a-b.

In FIG. 10, a schematic view of a method 100 for manufacturing a furniture is shown. The method 100 is performed by a first step 102 of providing at least two pre-manufactured furniture modules 10, wherein at least one furniture module 10 comprises a first furniture part 20a, and at least one furniture module 10 comprises a second furniture part 20b. A second step 104 is subsequently performed by providing at least one furniture connector 30 as described above, wherein said first and second furniture parts 20a-b are configured to be connected by means of said at least one furniture connector 30.

As a final assembly step, the method 100 may also involve a step 106 of connecting the furniture modules 10 by means of at least one furniture connector 30.

The examples described above allow for a much improved assembly of partly handmade furniture, even when deviations in dimensions are significant and where the tolerances are beyond standard specifications for industrial processes. Especially, the furniture connector 30 provides for a robust connection of the pre-manufactured furniture modules 10, which allows for knock-down packaging and distribution of furniture 1a-d of natural material of varying dimensions, such as rattan.

1. A furniture connector for establishing attachment between two pre-manufactured furniture parts, said furniture connector comprising
a screw, and
a washer configured to receive the screw and comprising a plate having a radius, and a through hole arranged in said plate, wherein the periphery of said through hole extends into a truncated cone in a direction away from said plate.

2. The furniture connector according to claim 1, wherein the plate of the washer is circular, rectangular, square, triangular or elliptical.

3. The furniture connector according to claim 1, wherein the outer dimension, such as the diameter, of the plate is between 1.5 and 4 cm, preferably between 2.4 and 2.6 cm.

4. The furniture connector according to claim 1, wherein the apex angle of the truncated cone of the washer is between 40° and 80°, preferably between 55° and 65°.

5. The furniture connector according to claim 1, wherein the length of the truncated cone of the washer is between 2 and 10 mm, preferably between 4 and 6 mm.

6. The furniture connector according to claim 1, wherein the radius of the plate is between 5 and 35 mm, preferably between 8 and 32 mm, more preferably between 10 and 25 mm, such as between 15 and 20 mm.

7. The furniture connector according to claim, wherein the screw comprises a screw head, a threaded portion, and a non-threaded portion arranged between the screw head and the threaded portion.

8. The furniture connector according to claim 7, wherein the screw head is countersunk.

9. The furniture connector according to claim 7, wherein the length of the non-threaded portion is between 5 and 30 mm, such as 10-25 mm.

10. The furniture connector according to claim 7, wherein the thread pitch of the threaded portion of the screw is between 2 and 4 mm, preferably between 2 and 3 mm.

11. The furniture connector according to claim 7, wherein the major diameter of the threads of the screw is between 4 and 8 mm, preferably between 5 and 7.5 mm, and even more preferably between 5.5 and 7 mm.

12. The furniture connector according to claim 7, wherein the minor diameter of the threads of the screw is between 3 and 6 mm, preferably between 3.5 and 5.5 mm, and even more preferably between 4.0 and 5.0 mm.

13. A kit for forming a furniture joint, the kit comprising a furniture connector according to claim 1, a first furniture part, and a second furniture part, wherein the screw of the furniture connector is arranged to be inserted in a pre-drilled hole of the first furniture part and to be screwed into a pre-drilled hole of the second furniture part, thereby attaching the first furniture part to the second furniture part.

14. The kit according to claim 13, wherein the pre-drilled hole of the first furniture part has an exterior end arranged to be opposite to the second furniture part and having a conical shape, and wherein the cone of the washer is configured to be received by the exterior end (22a) of the pre-drilled hole of the first furniture part.

15. The kit according to claim 13, wherein the pre-drilled hole (22) of the first furniture part (20a) is extending in a radial direction of a rounded portion of the first furniture part (20a).

16. The kit according claim 13, wherein the screw is extending in the radial direction of a rounded portion of the first furniture part, the rounded portion being tilted an angle from being perpendicular to the longitudinal direction of the screw, preferably the angle β being within ±15°.

17. The kit according to claim 13, wherein the pre-drilled hole of the second furniture part is extending in a radial direction of a rounded part of the second furniture part.

18. The kit according to claim 13, wherein the pre-drilled hole of the second furniture part is extending in an axial direction of the second furniture part.

19. The kit according to claim 18, wherein the pre-drilled hole of the second furniture part extends from an axial end of the second furniture part, wherein said axial end is having a conical shape.

20. The kit according to claim 19, wherein the pre-drilled hole of the first furniture part has an interior end arranged adjacent to the second furniture part and having a conical shape, and wherein the axial end of the second furniture part is arranged to be at least partly received by the interior end of the pre-drilled hole of the first furniture part.

21. The kit according to claim 20, wherein a conical friction engagement is provided between the conically shaped axial end of the second furniture part and the conically shaped interior end of the pre-drilled hole of the first furniture part, preferably the sole point of contact between the axial end of the second furniture part and the interior end of the pre-drilled hole of the first furniture part being the respective conical surfaces.

22. The kit according to claim 20, wherein the conically shaped axial end of the second furniture part and the conically shaped interior end of the pre-drilled hole of the first furniture part are designed such that after mounting, an axial gap is provided between the edge of the axial end and the inner end of the interior end.

23. The kit according to claim 22, wherein the axial length of the axial gap is in the range of 0.5-4 mm, preferably in the range of 1-2 mm.

24. The kit according to any of claim 13, wherein the second furniture part is provided with a dowel extending across the path of the pre-drilled hole of the second furniture part, preferably the dowel is made from a wooden material, more preferably a wood fiber direction of the dowel extends in a direction being perpendicular to the longitudinal direction of the screw

25. The kit according to claim 13, wherein at least one of said first furniture part and said second furniture part is at least partly made of rattan, preferably both the first and the second furniture parts are made from rattan.

26. A piece of furniture, comprising at least one kit for forming a furniture joint according to claim 13.

27. The piece of furniture according to claim 26, wherein the first and/or the second furniture part forms part of a pre-manufactured furniture module, and wherein the furniture module has a planar shape, preferably the piece of furniture is entirely made up furniture modules having a planar shape and/or being arranged for being flat-packed.

28. The piece of furniture according to claim 26, comprising a plurality of pre-manufactured furniture modules forming a seat, a back piece, and two side pieces, respectively, and wherein at least one furniture module comprises a first furniture part, and at least one furniture module comprises a second furniture part.

29. A method for manufacturing a piece of furniture suitable for being flat-packed, comprising
providing at least two pre-manufactured furniture modules, wherein at least one furniture module comprises a first furniture part, and at least one furniture module comprises a second furniture part, and
providing at least one furniture connector according claim 1, and/or at least one kit for forming a furniture joint according to claim 13, wherein said first and second furniture parts are configured to be connected by means of said at least one furniture connector and/or by means of said kit.
